(19) United States
(12) Patent Application Publication
(10) Pub. No.: US 2016/0335928 A1
(43) Pub. Date: Nov. 17, 2016

(54) FLUID-ACTIVATABLE POLYMERIC LABELS

(71) Applicant: Nulabel Technologies, Inc., East Providence, RI (US)

(72) Inventor: Benjamin D. Lux, Providence, RI (US)

(21) Appl. No.: 15/153,508

(22) Filed: May 12, 2016

Related U.S. Application Data
(60) Provisional application No. 62/160,180, filed on May 12, 2015.

(51) Int. Cl. G09F 3/10; B65C 9/20; G09F 3/02; C09J 7/02

(52) U.S. Cl. CPC G09F 3/10; C09J 7/02; B65C 9/20; G09F 3/02; C09J 125/08

(57) ABSTRACT

Fluid activatable adhesive labels, label systems, and methods of making and using thereof are described herein. These labels are particularly useful with facesheets with low MVTR due to the inclusion and placement of sequestration components within the labels. The sequestration components are either embedded in an adhesive layer, in a separate tie-layer between the adhesive layer and the substrate, incorporated in the substrate, or incorporated into the adherend. Preferably the labels are clear. Following application of an activation fluid and, preferably following activation of the activatable adhesive layer, the sequestration materials adsorb the fluid from the polymer adhesive components over time, such as for about 0 to 72 hours. This dries the label and wets the sequestration components. Optionally, the container with the label is also subjected to a drying step to dry the sequestration components.

### CROSS-REFERENCE TO RELATED APPLICATION

This application claims benefit of and priority to U.S. Ser. No. 62/160,180 filed on May 12, 2015, the disclosure of which is incorporated herein in its entirety.

### FIELD OF THE INVENTION

The invention is generally directed to fluid activatable adhesives, more particularly fluid activatable adhesives used with polymeric or film facesheets.

### BACKGROUND OF THE INVENTION

Fluid activatable adhesives are growing in commercial applications due to the low cost and ease of handling relative to traditional wet glues and pressure-sensitive adhesives. These are particularly applicable to the field of container decorating, specifically primary labeling. Generally, a dry, non-tacky adhesive layer is prepared on a facesheet using a coating or casting method. The non-tacky adhesive layer remains inert until it is activated by a fluid containing one or more solvents.

The solvents may swell, dissolve, or partially dissolve components in the adhesive layer allowing them to wet-out and adhere to a substrate, such as a container. During the swelling or dissolution process, the cohesive strength of the activatable adhesive layer is greatly decreased. The fluid and dry adhesive layer intermix. This greatly reduces the viscosity of the adhesive layer and allows the moisturized adhesive layer to generate tack and viscoelastic flow. These flow characteristics allow the adhesive the mobility to wet-out onto the substrate, while still maintaining a bond with the facesheet.

In systems where the facesheet and/or substrate have a sufficient moisture vapor transmission rate (MVTR) relative to the desired set/cure time and the solvents have a sufficient ability to volatilize, the evaporation of the fluids results in an increase in viscoelasticity of the adhesive layer. This results in an increase in cohesive strength. In systems where the fluid is volatile, the fluid in the adhesive will eventually evaporate leaving a cured adhesive bond between facesheet and substrate.

U.S. Pat. No. 8,334,336 to Lux et al., describes how the volatility of an activation fluid can be adjusted by adjusting its composition to allow for variable set/cure times. In some cases, components of the fluid can be non-volatile and serve as long lasting plasticizers in the adhesive layer. This is particularly useful in applications where flexibility and adhesion to lower surface energy plastics is needed.

While these types of systems work well when there is sufficient MVTR in the substrate to allow the evaporation of the fluid, they fail when the MVTR of the system prevents fluid evaporation. The failure is typically a cohesive failure of the adhesive layer. As fluid cannot evaporate or otherwise be absorbed, the result is a weak boundary layer between the substrate and facesheet.

Therefore there is a need for improved fluid activatable adhesive labels and fluid activatable adhesive systems, particularly ones that can be used with substrates having a low MVTR.

### SUMMARY OF THE INVENTION

Fluid activatable adhesive labels, label systems, and methods of making and using thereof are described herein. The labels are low cost, readily available label systems for high volume commodity label markets. The labels adhere to substrates with high or low MVTR. These labels are particularly useful with facesheets with low MVTR due to the inclusion and placement of sequestration components within the labels. The sequestration components are embedded in or incorporated into one or more layers of the label, such as an adhesive layer, a separate tie-layer between the adhesive layer and the facesheet, in a primer-layer, the facesheet, or the substrate. Following application of an activation fluid, the sequestration components adsorb the residual fluid from the adhesive layer over time, such as for about 0 to 72 hours following application of the activation fluid to the activatable adhesive layer. Preferably, the sequestration components begin adsorbing the residual activation fluid after activation of the activatable adhesive layer. This dries the label and wets the sequestration components. Optionally, the container with the label is also subjected to a drying step to dry the sequestration components.

### BRIEF DESCRIPTION OF THE DRAWINGS

FIGS. 1A, 1B, 1C, and 1D are cross-sectional views of four exemplary labels and containers, prior to activation of an adhesive layer. As shown in FIG. 1A, an indicia layer is on top of a facesheet, a plurality of sequestration components is included in a separate layer located between a facesheet and adhesive layer. FIG. 1B depicts a label with the same structure as shown in FIG. 1A, with the addition of an overprint layer on top of an indicia layer. FIG. 1C depicts a label with the same structure as shown in FIG. 1B, with the addition of a primer layer located between a facesheet and a sequestration layer. Additionally, in the label depicted in FIG. 1C the sequestration components are embedded in the primer layer, not the sequestration layer. FIG. 1D depicts a label with the same structure as shown in FIG. 1C, however the sequestration layer is absent. In the label depicted in FIG. 1D, the primer layer is located between an adhesive layer and a facesheet.

FIGS. 2A, 2B, and 2C are cross-sectional views of another set of exemplary labels and containers, prior to activation of an adhesive layer. As shown in FIG. 2A, an overprint layer is on top of an indicia layer; a plurality of sequestration components is incorporated in an adhesive layer. FIG. 2B depicts a label with the same structure as shown in FIG. 2A, with the addition of a primer layer. FIG. 2C depicts a label with the same structure as shown in FIG. 2B, however the sequestration components are located in the primer layer, instead of the adhesive layer.

FIGS. 3A and 3B are cross-sectional views of another pair of exemplary labels and containers, prior to activation of an adhesive layer. As shown in FIG. 3A, an indicia layer is incorporated into an overprint layer; a plurality of sequestration components is included in a separate layer located between a facesheet and an adhesive layer. FIG. 3B depicts a label with the same structure as shown in FIG. 3A, with the addition of a primer layer located between a facesheet and a sequestration layer. Optionally a plurality of sequestration particles is included in the primer layer.

FIGS. 4A and 4B are cross-sectional views of another pair of exemplary labels and containers, prior to activation of an adhesive layer. As shown in FIG. 4A, an indicia layer is incorporated into an overprint layer; a plurality of sequestration components is incorporated in an adhesive layer. FIG. 4B depicts a label with the same structure as shown in FIG. 4A, with the addition of a primer layer located between a facesheet and an adhesive layer. Optionally a plurality of sequestration components is included in the primer layer.

FIGS. 5A and 5B are graphs of equilibrium water capacity at 77° F. and 75% relative humidity (grams adsorbed per 100 grams of adsorbent) over time (in hours) (FIG. 5A) and equilibrium water capacity at 77° F. (grams adsorbed per 100 grams of adsorbent) over changes in percent relative humidity (FIG. 5B) for different materials exposed to water. These graphs were obtained from https://www.sorbentsystems.com/desiccants_charts.html.

### DETAILED DESCRIPTION OF THE INVENTION

I. Label System with fluid activatable adhesive

As used herein the term “label system” refers to the label and fluid activatable adhesive prior to activation of the adhesive, optionally with a suitable activation fluid.

As used herein the term “label” generally refers to a facesheet or facestock with indicia, optionally with a further coating on top of the indicia, or onto which the indicia is printed.

The terms “styrene acrylic” and “acrylic styrene” as they relate to copolymers, are used interchangeably to refer to copolymers having the general structure shown below:

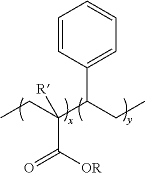

wherein x and y are independently integers from 1 to 1000, each occurrence of R′ is independently hydrogen, substituted or unsubstituted alkyl, or substituted or unsubstituted aryl, and each occurrence of R is independently hydrogen, substituted or unsubstituted alkyl, or substituted or unsubstituted aryl. The copolymer can be random, block, branched, or combinations of these. Examples of copolymers of styrene acrylic include, but are not limited to, poly(styrene-co-alkyl methacrylate), such as poly(styrene-co-methyl methacrylate), poly(styrene-co-alkyl acrylate), such as poly(styrene-co-methyl acrylate), poly(styrene-co-methacrylic acid), and poly(styrene-co-acrylic acid)).

“Water-soluble”, as used herein, generally means at least about 10 g is soluble in 1 L of water, i.e., at neutral pH, at 25° C.

“Water-insoluble”, as used herein, generally means less than about 10 g is soluble in 1 L of water, i.e., at neutral pH, at 25° C.

“Alkaline-soluble”, as used herein, generally means at least about 10 g is soluble in 1 L of an alkaline solution, which has a pH of greater than 7 at 25° C.

“Alkaline-insoluble”, as used herein, generally means less than about 10 g is soluble in 1 L of an alkaline solution, which has a pH greater than 7 at 25° C.

A. Configurations

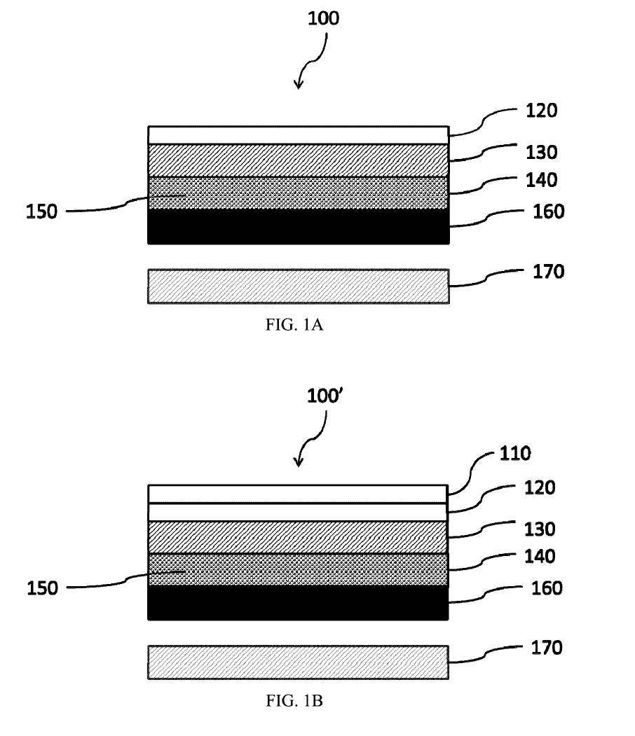

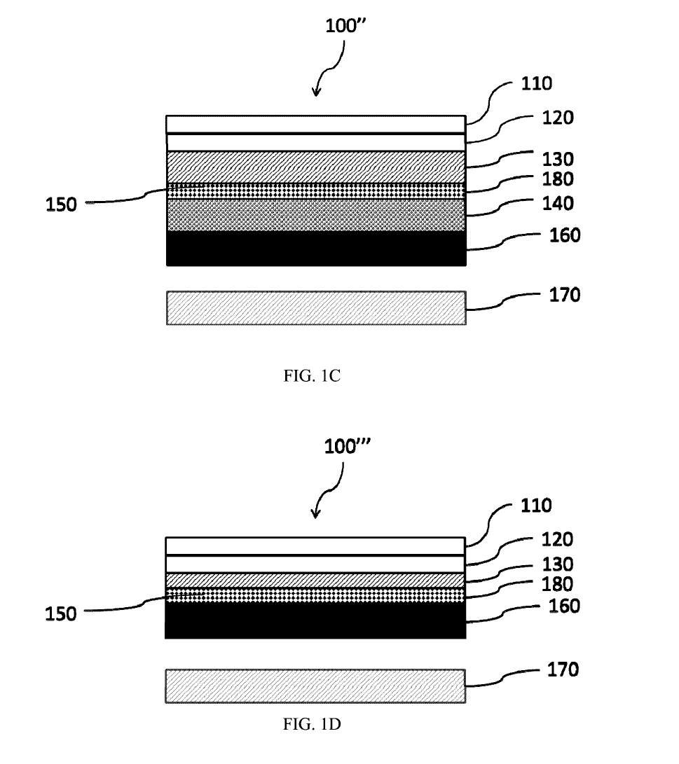

In one embodiment, the label system 100 includes an indicia layer 120, a facesheet 130, a plurality of sequestration components 150, and an adhesive layer 160. See, e.g. FIGS. 1A-1D. In some embodiments, the label system 100′ includes an overprint layer 110, an indicia layer 120, a facesheet 130, a sequestration layer 140, containing a plurality of sequestration components 150, and an adhesive layer 160. See FIG. 1B. In some embodiments, the label system 100″ includes a primer layer 180. The primer layer 180 is located between the facesheet and the sequestration layer, while the sequestration layer is located between the adhesive layer 160 and the primer layer 180. See, FIG. 1C. The primer layer optionally contains all or a portion of the sequestration components 150. In another embodiment, the label system 100′″, contains an overprint layer 110, an indicia layer 120, a facesheet 130, an adhesive layer 160, and a primer layer 180 that contains a plurality of sequestration components 150. The primer layer 180 layer optionally contains all or a portion of the sequestration components 150. When the primer layer 180 is present and the sequestration components 150 are located in the primer layer 180, a separate sequestration layer 140, is not required. See, FIG. 1D. The label systems 100, 100″, 100″, and 100′″ can be applied to a substrate, such as a container 170.

The overprint layer can be above or below the indicia layer, or can be combined with the indicia layer to form a combined overprint and indicia layer.

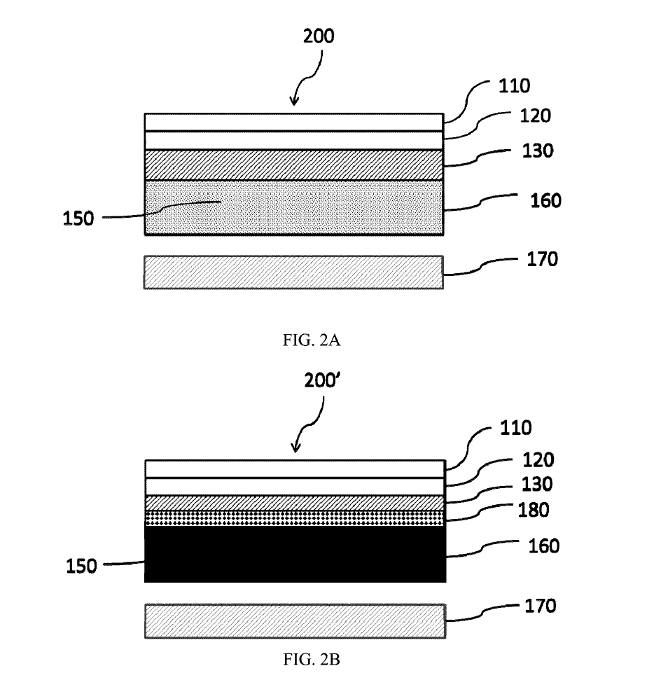

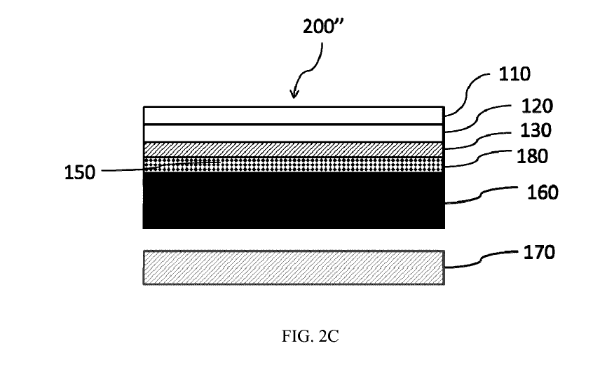

In another embodiment, the label system 200 includes an overprint layer 110, an indicia layer 120, a facesheet 130, and an adhesive layer 160 that contains a plurality of sequestration components 150. See, FIG. 2A. In another embodiment, the label system 200′ includes an overprint layer 110, an indicia layer 120, a facesheet 130, a primer layer 180, and an adhesive layer 160 that contains a plurality of sequestration components 150. See, FIG. 2B. In yet another embodiment, the label system 200″ includes an overprint layer 110, an indicia layer 120, a facesheet 130, an adhesive layer 160, and a primer layer 180 that contains a plurality of sequestration components 150. See, FIG. 2C. The label systems 200, 200′, and 200″ can be applied to a substrate, such as a container 170.

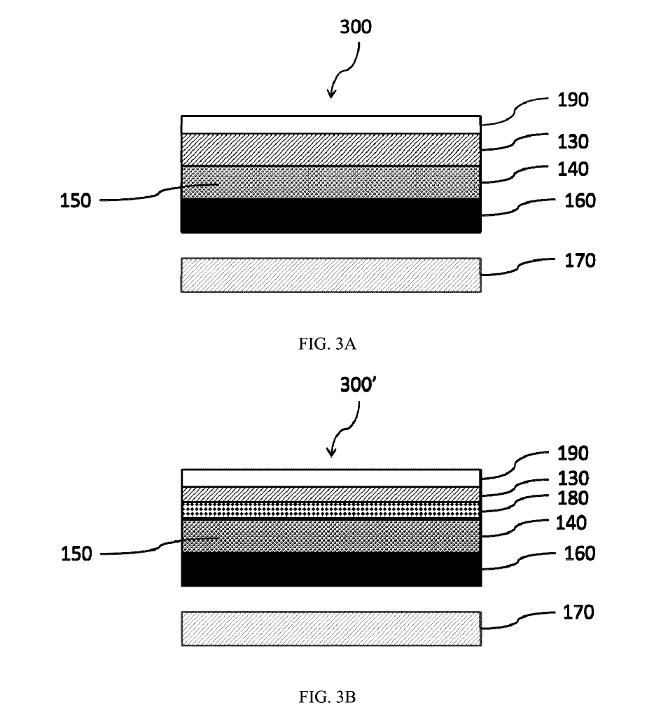

In yet another embodiment, the label system 300 includes an overprint and indicia layer 190, a facesheet 130, a sequestration layer 140 that contains a plurality of sequestration components 150, and a separate adhesive layer 160. See, FIG. 3A. In yet another embodiment, the label system 300′ includes an overprint and indicia layer 190, a facesheet 130, a primer layer 180, a sequestration layer 140 that contains a plurality of sequestration components 150, and a separate adhesive layer 160. See, FIG. 3A. The sequestration layer is located between the adhesive layer 160 and the primer layer 180. The label systems 300 and 300′ can be applied to a substrate, such as a container 170.

In another embodiment, the label system 400 includes an overprint and indicia layer 190, a facesheet 130 and an adhesive layer 160 that contains a plurality of sequestration components 150. In another embodiment, the label system 400′ includes an overprint and indicia layer 190, a facesheet 130, a primer layer 180 and an adhesive layer 160 that contains a plurality of sequestration components 150. The label systems 400 and 400′ can be applied to a substrate, such as a container 170.

It is to be understood that for the label systems described herein, all the sequestration components can be located in a single layer, in combinations of layers, or they can be located simultaneously in all the layers. Further, one or more layers of the label systems are optional. For example, in some embodiments, the sequestration layer 140 is optional. In other embodiments, the primer layer 180 is optional.

B. Label

The labels described herein are low cost, readily available label systems for high volume commodity label markets. The labels adhere to substrates with high or low MVTR, and are particularly useful with low MVTR substrates due to the inclusion and placement of sequestration components within the labels. The labels are also durable, flexible, and resistant to moisture, corrosion, curl, and abrasion, or combinations thereof. In some embodiments, the labels are glossy, transparent, colored, or a combination thereof. In other embodiments, the labels are glossy, opaque, colored, or a combination thereof.

i. Properties 1. Clarity

In some embodiments, the label has a clarity of 0% to 20%, as measured by percent haze, preferably 0% to 15%, most preferably 0% to 10%. In another embodiment, nano/micrometer scale silica gel spheres are used to obtain a clear label.

Clarity is also obtained using solvent-based coatings that are clear. Examples of components used to form the solvent-based coatings include, but are not limited to, styrene maleic anhydride (SMA) resins, styrene acrylate (SA) resins, butyl-acrylate, 2-ethylhexyl-acrylate, acrylic, nitrocellulose, cellulose acetate propionate as well as many of the components listed in the adhesive section.

One of skill in the art understands that a desired clarity can be obtained by varying different properties of the components of the label system, such as varying the sizes of the sequestration components, using sequestration components with colors, and/or using different solvents, indicia layer, overprint layer, adhesive coating layer, or label facesheet, or combinations thereof with suitable clarities to achieve the desired overall clarity in the label.

2. Moisture Vapor Transmission Rate (MVTR)

MTVR values can be measured using any suitable method, such as the TAPPI T448 om-09 standard protocol, and ASTM E96/E96M-10. In some embodiments, the MVTRs of the label facesheet, indicia layer and overprint layer are independently high or low. Low MVTR values are less than about 150 g/m²/24 hr, preferably less than 100 g/m²/24 hr, and most preferably less than 50 g/m²/24 hr. High MVTR values are those that are equal to or greater than 150 g/m²/24 hr, preferably greater than 175 g/m²/24 hr, and most preferably greater than 200 g/m²/24 hr. It is to be understood that the component of the label system with the lowest MVTR value, is the rate-limiting component. The label system still effectively adheres to substrates at the rate-limiting MVTR value.

3. Components

a. Facesheet

The facesheet provides a support surface on which the indicia layer and overprint layer (if a separate over print layer is present) are coated on one side, while the fluid activatable adhesive material is attached to the opposite side. In some embodiments, the opposite side of the facesheet 130 is first coated with a primer layer 180 that promotes adhesion of the activatable adhesive layer 160 to the facesheet 130. See, FIG. 1D.

In some embodiments, the opposite side of the facesheet 130 is first coated with a primer layer 180 that contains sequestration components 150 and then coated with a sequestration layer 140. See, FIG. 1C.

In yet other embodiments, the opposite side of the facesheet 130 is first coated with a sequestration layer 140, and subsequently coated with the adhesive layer 160. See, FIGS. 1A and 1B.

b. Materials

The facesheet can be formed from a variety of different materials, such as for example, polypropylene, high/low density polyethylene, polyethylene terephthalate, polycarbonate, poly(butyl methacrylate-co-methyl methacrylate), polyethylene oxide, polypropylene oxide, polyamide, polylactic acid, polystyrene, cellophane, polyvinyl ethers, polyvinyl esters, polyvinyl halides such as poly(vinyl chloride), polyvinylpyrrolidone, polysiloxanes, poly(vinyl alcohols), poly(vinyl acetate), polyesters, polyurethanes and co-polymers thereof, derivativized celluloses such as alkyl cellulose, hydroxyalkyl celluloses, cellulose ethers, cellulose esters, nitro celluloses, methyl cellulose, ethyl cellulose, hydroxypropyl cellulose, hydroxy-propyl methyl cellulose, hydroxybutyl methyl cellulose, cellulose acetate, cellulose propionate, cellulose acetate butyrate, cellulose acetate phthalate, carboxylethyl cellulose, cellulose triacetate, and cellulose sulphate sodium salt (jointly referred to herein as “synthetic celluloses”), polymers of acrylic acid, methacrylic acid or copolymers or derivatives thereof including esters, poly(methyl methacrylate), poly(ethyl methacrylate), poly(butylmethacrylate), poly(isobutyl methacrylate), poly(hexylmethacrylate), poly(isodecyl methacrylate), poly(lauryl methacrylate), poly(phenyl methacrylate), poly(methyl acrylate), poly(isopropyl acrylate), poly(isobutyl acrylate), and poly(octadecyl acrylate) (jointly referred to herein as “polyacrylic acids”), poly(butyric acid), poly(valeric acid), and poly(lactide-co-caprolactone), copolymers and blends thereof.

c. Properties

Preferably, the facesheet is non-porous, i.e., it has an MVTR less than 150 g/m²/24 hr, preferably less than 100 g/m²/24 hr, and most preferably less than 50 g/m²/24 hr.

However, the sequestration components described herein can optionally be used in label systems where the facesheet is porous, i.e., it has an MVTR greater than 150 g/m²/24 hr, preferably greater than 175 g/m²/24 hr, and most preferably greater than 200 g/m²/24 hr.

In some embodiments, the facesheet is a polymeric material, i.e., formed from polymers, such as those described above. In some embodiments, the facesheet is non-tacky, durable, flexible, and resistant to tearing, moisture, corrosion, curl, abrasion, or combinations thereof. In some embodiments, the facesheet has a clarity of 0% to 20% haze, as measured by percent haze, such as using ASTM-D100, preferably 0% to 15% haze, most preferably 0% to 10% haze. The percent haze (i.e. clarity) can be determined using a haze meter, such as the “haze-gloss” instrument available from BYK-Gardner. In some embodiments, the facesheet is colored.

The facesheet can have any suitable thickness for the particular application, such as the type and overall look of the label, and the container to which the label will be applied. Typical thicknesses for the facesheet range from 10 μm to 500 μm.

4. Indicia Layer

The indicia layer 120 is formed from an ink/dye/pigment formulation that is applied to the facesheet 130. The indicia layer 120 provides decoration to the substrate, information about the contents in the substrate, or both.

The ink/dye/pigment formulation includes carrier solvents and materials dissolved in the solvents. Suitable materials that can be dissolved in the carrier solvents include, but are not limited to, a resin, a surfactant and a colorant. The ink/dye/pigment formulations can contain smaller amounts of other ingredients without hindering the desired properties of the inks. Such ingredients include, but are not limited to, dispersants, anti-foaming agents, wetting agents, viscosity modifiers, and light stabilizers.

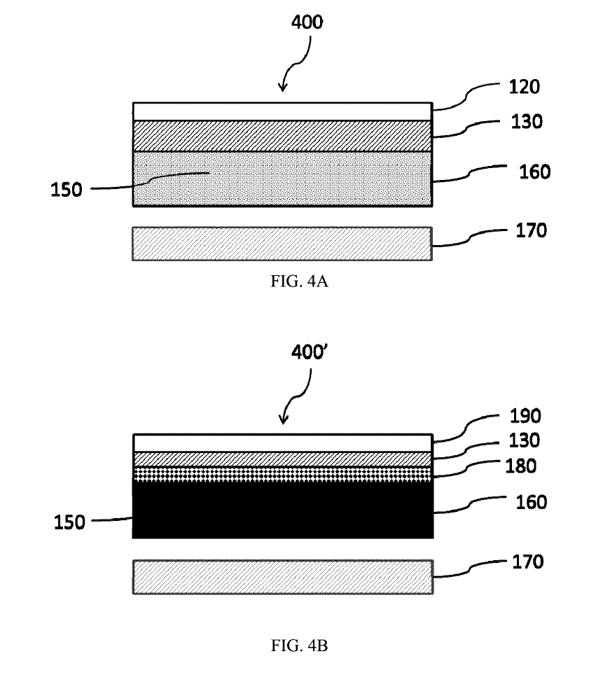

In some embodiments, an overprint layer 110 is coated onto and is a separate layer from the indicia layer 120, as shown in FIGS. 1A-1D and 2A-2C. In other embodiments, the indicia layer is incorporated into the overprint layer to form an indicia and overprint layer 190, as shown in FIGS. 3A-3B and 4A-4B.

a. Solvent

Generally, the solvent can be any material that can dissolve the resin and other materials in the ink/dye/pigment formulation. Depending on the choice of a substrate for which an ink/dye/pigment formulation is targeted, a solvent (such as an organic solvent) can be selected based on the evaporation rate of a solvent.

Certain non-aqueous inks have been disclosed in U.S. Patent Application Publication Nos. US 2005/0039634 to Hermansky, US 2009/0246377 to Robertson, et al., and US 2010/0098860 to Robertson, et al. and in published PCT applications WO 2010/042104 to Barreto, et al. and WO 2010/042105 to Barreto, the entire contents of which are incorporated herein by reference.

The approach described above, using different types of solvent, is well suited to develop conventional printing inks. Also contemplated are materials and approaches employed to develop other types of printing inks, such as toner inks for a laser printer. For example, U.S. Pat. No. 8,206,884 to Yang, et al., describes a method for preparing toner using micro-suspension particles, the entire contents of which are incorporated herein by reference.

b. Resin

The resin typically provides the ink/dye/pigment formulation with a desired viscosity, thermal stability, flexibility, and adhesion properties.

c. Surfactant

Optionally, the ink/dye/pigment formulation includes one or more surfactants. The surfactant(s) can serve to alter the surface tension of the ink/dye/pigment formulation. Suitable types of surfactants include, but are not limited to, anionic (such as sulfate esters, carboxylates, sulfonates, or phosphonates), cationic, nonionic (such as polyol based, polyglycerols based, fluorocarbon based, siloxane-based, alkyl phenol based, or polyoxyethylene based) or amphoteric (such as phosphatides, imidazoline derivatives, or betaines) surfactant compounds, such as those described in “Surfactants and Interfacial Phenomena,” Second Edition, M. J. Rosen, 1989, John Wiley and Sons, Inc., New York, pages 1-32, the contents of which are incorporated herein by reference.

The inclusion of a surfactant within an ink/dye/pigment formulation can lead to a barrier in the form of a layer of surfactant at the interface of air and bulk ink, thereby reducing, and preferably substantially eliminating, the ability of the solvent to evaporate from the bulk ink/dye/pigment formulation. By reducing the solvent evaporation rate, and preferably entirely preventing solvent evaporation of the ink/dye/pigment formulations, the decap time can be increased. At the same time, once an ink/dye/pigment formulation is placed onto a substrate, fast evaporation (i.e., fast drying time) can occur because the surfactant molecules can spread out over a larger surface area instead of being confined to a surface that is under tension.

d. Colorants

The ink/dye/pigment formulation may include one or more colorants, which provide color to the ink/dye/pigment formulation. The ink/dye/pigment formulation can contain a sufficient amount of a colorant that the ink/dye/pigment formulation has color, but not so much as to interfere with other desirable qualities, such as surface tension or viscosity.

An ink/dye/pigment formulation can include one or more colorants (e.g., one or more pigments, one or more dyes, or their mixtures). Colorants can provide an ink/dye/pigment formulation with, for example, a desired color and/or opacity. Exemplary colors can include black, cyan, magenta, yellow, blue, green, brown, or their combinations

5. Overprint Layer

The overprint layer provides durability to the indicia and generally protects the indicia (printing ink) from damage, such as due to finger prints, moisture, scratches. The overprint layer can be formed from water and/or solvent-based polymers such as polymethacrylic acid, poly(styrene-co-methacrylic acid), polyacrylic acid, poly(styrene acrylic acid), or combinations thereof.

The overprint layer can be above or below the indicia layer, or can be combined with the indicia layer to form a combined overprint and indicia layer.

C. Sequestration Components

The sequestration components remove and sequester the activation fluid partially or completely, after the fluid activatable adhesive has been activated and applied to a substrate. This allows the internal strength of the fluid activatable adhesive to increase after activation despite the low MVTR of the facesheet. In some embodiments, the sequestration components also sequester moisture from the surface of the substrate. Sequestering moisture from the surface of the substrate is particularly useful when the surface of the substrate (e.g. a container) to which the label is applied is moist or has condensation. In some embodiments, the sequestration components are in particulate form, non-particulate form, or both.

In some embodiments, the sequestration components selectively sequester or trap certain components in the coating formulation of the sequestration components, the activation fluid, or both. The sequestration components generally sequester or trap water.

After the adhesive achieves the desired viscoelastic effect, the sequestration components begin to dehydrate the polymers in the adhesive film.

This is of use in building non-tacky activatable adhesives that once activated and cured/set remain partially tacky or plasticized.

The sequestration components (either embedded in the adhesive layer, in a separate tie-layer, such as a sequestration layer, between the adhesive layer and the facesheet, incorporated in the facesheet, a primer layer, and/or incorporated into the substrate) adsorb the fluid from the polymer adhesive components over time, such as for about 0 to 72 hours following activation of the adhesive layer, resulting in the drying of the label and the wetting of the sequestration components.

i. Materials

The selection of the sequestration components 150 is based on the components of the adhesive layer 160, the optional primer layer 180, as well as the activation fluid. In some embodiments, the sequestration components 150 form a separate layer, the sequestration layer 140, which is located between the facesheet 130 and the adhesive layer 160, as shown in FIGS. 1A, 1B, 3A, and 3B. In some embodiments the sequestration components 150 are incorporated into the adhesive layer 160, as shown in FIGS. 2A, 2B, 4A, and 4B. Optionally, the sequestration components 150 are incorporated into the primer layer 180.

In some embodiments, the sequestration components are polymeric, non-polymer, or both. The sequestration components are dissolved or suspended in an appropriate solvent, such as water or acrylic polymer emulsion. Suitable sequestration components include, but are not limited to, fumed silica, colloidal silica, hygroscopic silica, silica gels (such as SiliFlash® Irregular Silica gels, C60 silica, Silicycle), silica alumina gels; mesoporous silica (MCM-41, ExxonMobil; Santa Barbara Amorphous material 15 (SBA-15)) and alumina, silica and alumina micro particles, nanoporous silica, silica-alumina, and alumina; mesoporous and/or particles of oxides of alumina, niobium, tantalum, titanium, zirconium, cerium and tin; zeolite molecular sieves, other zeolite based desiccants; carbon nanotubes, graphene; traditional chemical/waters scavengers including those functionalized onto silica, such as SiliaBond® Amine, SiliaBond® DMAP, SiliaBond® Diamine, SiliaBond® Triamine, SiliaBond® Carbonate, SiliaBond® Propylsulfonic, SiliaBond® Succinic, SiliaBond® Tosic, SiliaBond® Succinic, SiliaBond® Tosyl, SiliaBond® Tosic, and SiliaBond® Isocyanate all by SiliCycle Inc. (Montreal City, Canada); activated carbon, activated alumina; aerogel, benzophenone, bentonite clay, calcium chloride, calcium sulfate, lithium chloride, lithium bromide, magnesium sulfate, magnesium perchlorate, potassium carbonate, sodium chlorate, sodium chloride, sodium hydroxide, sodium sulfate, sodium silicate, potassium silicate, and sucrose; polymeric ion exchange resins, such as quaternary ammonium resins (e.g., Amberlite®/Amberlyst®/Amberjet®); polyvinylpyrrolidone, polyvinylpyrrolidone vinyl acetate, and crosslinked polyvinylpyrrolidone; Kaolin and other clays; and polymethylsiloxane polyhydrate.

Suitable polymeric sequestration components include, but are not limited to, acrylate copolymers that include copolymers of two or more monomers consisting of acrylic acid, methacrylic acid or one of their simple esters, other copolymers of acrylic acid and other monomers including Ammonium Acrylates Copolymer, Ammonium VA/Acrylates Copolymer, Sodium Acrylates Copolymer, Ethylene/Acrylic Acid Copolymer, Ethylene/Calcium Acrylate Copolymer, Ethylene/Magnesium Acrylate Copolymer, Ethylene/Sodium Acrylate Copolymer, Ethylene/Zinc Acrylate Copolymer, Ethylene/Acrylic Acid/VA Copolymer, Acrylates/VP Copolymer, Acrylates/VA Copolymer, Steareth-10 Allyl Ether/Acrylates Copolymer, Acrylates/Steareth-50 Acrylate Copolymer, Acrylates/Steareth-20 Methacrylate Copolymer, Acrylates/Ammonium Methacrylate Copolymer, Styrene/Acrylates Copolymer, Styrene/Acrylates/Ammonium Methacrylate Copolymer, Ammonium Styrene/Acrylates Copolymer, Sodium Styrene/Acrylates Copolymer, Acrylates/Hydroxyesters Acrylates Copolymer, Methacryloyl Ethyl Betaine/Acrylates Copolymer, Lauryl Acrylate/VA Copolymer, VA/Butyl Maleate/Isobornyl Acrylate Copolymer, Ethylene/Methacrylate Copolymer, Vinyl Caprolactam/VP/Dimethylaminoethyl Methacrylate Copolymer (such as Gaffix® Copolymer VC-731 from Ashland Inc.), Sodium Acrylates/Acrolein Copolymer, VP/Dimethylaminoethylmethacrylate Copolymer, AMP-Acrylates Copolymer), polymers of acrylic acid and its salts (Polyacrylic Acid, Ammonium Polyacrylate, Potassium Aluminum Polyacrylate, Potassium Polyacrylate, Sodium Polyacrylate).

Additional sequestration components include, but are not limited to, boehmite, pseudoboehmite calcium carbonate, chalk, magnesium carbonate, calcined clay, pyropylate, bentonite, talc, synthetic aluminum silicates, synthetic calcium silicates, diatomatious earth, anhydrous silicic acid powder, aluminum hydroxide, barite, barium sulfate, gypsum, and organic particles, such as hydrophilic and/or hydrophobic polymeric beads including but not limited to polyamides, polyvinyl alcohol, polyvinylpyrrolidone, polyvinylpyrrolidone vinyl acetate and other similar materials as well as combinations of the above materials.

Ion Exchange Resins

In some embodiments, the sequestration components include one or more ion exchange resins.

In some embodiments, the ion exchange resins are used as dessicants. Ion exchange resins may be used as desiccants for organic solvents, after having been dried to a low moisture level, in a manner similar to the use of silica gels and molecular sieves. The ion exchange resins have the advantage of being very easily regenerated (dried) at low temperatures relative to other desiccants.

In some embodiments, the ion exchange resins are particularly useful as sequestration components for the removal of water from the adhesive or sequestration layers. They have the added benefit of being able to remove water without being saturated by non-polar solvents, in such systems where water and non-polar co-solvents are used together.

Exemplary ion exchange resins are quaternary ammonium resins (such as Amberlite®/Amberlyst®/Amberjet®).

Molecular Sieves

In some embodiments, the sequestration components include one or more molecular sieves. Molecular sieves are excellent sequestration components due to their established ability to dry (remove water) from solvents.

Molecular sieves (also known as Synthetic Zeolite) contain a uniform network of crystalline pores and empty adsorption cavities, which give it an internal adsorptive surface area of 700 to 800 m²/g (½ the total volume of the crystals). Because of its uniform structure, molecular sieve will not give up moisture into the environment as readily as silica gel or clay as temperatures rise.

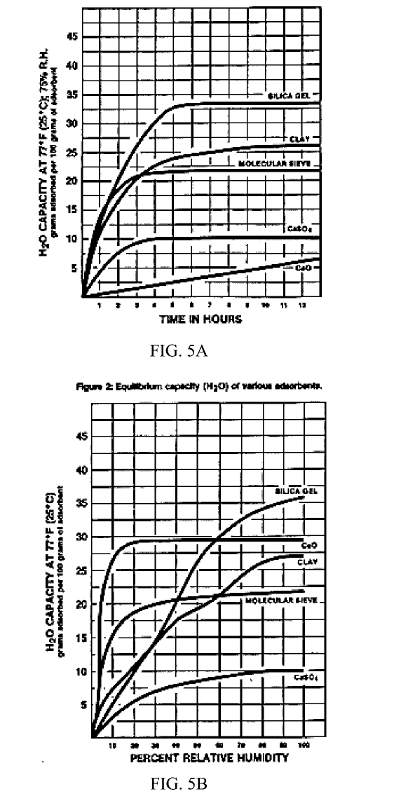

Molecular sieves adsorb moisture more strongly than either silica gel or clay; even though molecular sieves have a lower wt/wt capacity than silica gels and some clays. This can be seen by the high initial slope of the adsorption isotherm for molecular sieve as compared to the other desiccants in FIGS. 5A and B (obtained from https://www.sorbentsystems.com/desiccants_charts.html). This can also be seen in comparing their heats of adsorption for water. The heat of adsorption is the sum of the latent heat of vaporization of water and the heat of wetting. The heat of wetting will vary as a function of the saturation level of the desiccant. For purposes of comparison, the heat of adsorption for water on molecular sieve is about 1800 BTU/lb. of water adsorbed, as compared to 1300 BTU/lb. of water adsorbed on silica gel. Clay is roughly similar to silica gel in this respect.

This is significant, because in adhesive label systems where a low relative humidity is required, molecular sieves are efficient because of their high adsorption capacity at low relative humidity. Also, molecular sieves will not give up moisture back into the layer as readily as silica gel or clay as temperatures rise.

Using a combination of molecular sieves and silica gels in a single layer presents the ability to meet the kinetic and target moisture demands of a system that needs a very low final local relative humidity.

In some embodiments, zeolite molecular sieves with 3-Å pores are used in solvent-based, anhydrous sequestration component coating formulations. The sequestration component coating formulation is designed to only contain relatively larger molecules (compared to water), and carried in an organic solvent such as ethyl acetate (which is also larger than water). The sequestration component coating formulation can be dehydrated using typical anhydrous preparation techniques known in the art. The 3-Å molecular sieves are added to the sequestration component coating formulation (along with other sequestration agents) and are not activated by any of the components. The adhesive with sequestration components (either in a single layer or as multiple layers) is coated and the solvent is dried. The result is a polymeric film or facesheet coated with a clear adhesive/sequestration construction.

An example of a fluid activatable adhesive label system with a molecular sieve is one in which the molecular sieves have 3-Å pore diameters. If the activation fluid contains a combination of water and diethylene glycol monoethyl ether (DEGEE), after activation of the adhesive, the molecular sieves adsorb water from the film, but DEGEE is size excluded due to the smaller pore sizes on the molecular sieves compared to the size of DEGEE, thereby leaving DEGEE in the adhesive layer. The DEGEE may optionally be partially captured in other sequestration components or left in the adhesive layer to plasticize the adhesive. Thus, for example, an activation fluid containing 95% water and 5% DEGEE immediately swells the polymers in the adhesive layer giving a desired viscoelastic effect.

Additional examples of molecular sieves include, but are not limited to, microporous, mesoporous and macroporous materials.

In some embodiments the microporous materials (<2 nm or 20 Å) are selected from the group consisting of, zeolites (aluminosilicate minerals, different from aluminium silicate), zeolite LTA (3-4 Å), porous glass (1 nm or 10 Å) or greater, activated carbon (0-20 Å or 0-2 nm) or greater, clays such as montmorillonite intermixes, halloysite (endellite), and combinations thereof. Halloysite has two common forms, a hydrated form exhibiting a 1-nm or 10-A spacing of the layers, and a dehydrated (meta-halloysite) exhibiting a spacing of 0.7 nm or 7 Å. Halloysite naturally occurs as small cylinders which average 30 nm or 300 Å in diameter, with lengths between 0.5 and 10 micrometers, or 5×10³ and 1×10⁵ Å.

In some embodiments, the mesoporous material (2-50 nm or 20-500 Å) is silicon dioxide (used to make silica gel) (2.4 nm or 24 Å).

In some embodiments, the macroporous material (>50 nm or >500 Å) is silica (20-100 nm or 200-1000 Å).

1. Sequestration Additives

In some embodiments, one or more additives are incorporated into the layer that contains the plurality of sequestration components to provide indication of the status of the components. As an example, an indicator such as cobalt (II) chloride or copper (II) sulfate may be included in the sequestration components to show, by color changes, the degree of water-saturation of sequestration components. Anhydrous cobalt (II) chloride is brown. When it binds with two water molecules, it turns blue. This color change allows an operator or manufacturer to know whether the adhesive layer or sequestration components were properly dried and able to function. Other color indicators could be used in place of cobalt (II) chloride.

ii. Properties

1. Size

In some embodiments, the sequestration components are in particulate form. The size of the particles determines not only the clarity of the adhesive, but also the clarity of the label system. In some embodiments, the sizes of the particles are in the range from about 1 to about 20,000 nm, preferably from about 250 to about 1,000 nm, and most preferably from about 50 to about 400 nm. The sizes of the particles can be determined using dynamic light scattering and/or laser diffraction, which are two well-established techniques for measuring particle size from 1 um down to 1 nm resolution. Microtrac (York, Pa.) supplies analytical instruments for measuring particle size. These size ranges, i.e., from about 1 to about 20,000 nm, from about 250 to about 1,000 nm, and from about 50 to about 400 nm, are particularly preferred for labels with a clear facesheet.

2. Regeneration

Different sequestration components have different capacities to sequester different activation fluids. Sequestration components can become saturated. However, heating or other processes can release the adsorbed and/or absorbed fluid during a process called desiccant regeneration.

In embodiments where the components in the activation fluid are similar to those in the sequestration layer or adhesive layer, suitable sequestration components are those that after becoming saturated can be regenerated under typical conditions in flexographic and gravure printing processes.

Preferred sequestration component materials are able to regenerate when subject to typical printer conditions, i.e., at ambient pressure and at temperatures ranging from about 60° C. to about 150° C., preferably from about 60° C. to about 100° C.

Many sequestration agents possess the ability to be regenerated through a heating process. Often times, the heat required to regenerate the material is relatively low, such as at a temperature in the range from about 60° C. to about 150° C.—preferably from about 60° C. to about 100° C. for a period of time ranging from 1 minute, or less than 1 minute, such as 10-50 seconds, to 1 hour and within typical processing capabilities of the coating or printing equipment used to coat the material.

In the case of silica gels, moisture affinity decreases as the material approaches its saturation point. If a silica gel is in an environment that is relatively dry, it will release moisture without the addition of heat to reach an equilibrium state of saturation. This characteristic of reaching an equilibrium state of saturation relative to the surrounding local environment is typical of many of the suitable sequestration materials. This presents a challenge in building an activatable adhesive layer that needs to be dried (after activation and application) beyond a given equilibrium point of saturation. It is often necessary to dehydrate or dry the adhesive layer beyond this equilibrium point of saturation to form strong bonds between substrate and facesheet.

iii. In a Sequestration Layer in the Label

In some embodiments the sequestration components are in a separate layer, referred to herein as a “sequestration layer”, between the fluid activatable adhesive layer and the facesheet. The purpose of this layer is to hold a high concentration of sequestration components. In some embodiments, the sequestration layer promotes adhesion between the adhesive layer and the substrate.

In some embodiments, the sequestration layer contains a polymer or co-polymer film with a high loading, such as from about 20% to about 90% wt/wt, preferably from about 50% to about 90%, of sequestration components. Optionally, the polymer or co-polymer film itself also sequesters activation fluid components. Optionally, the sequestration layer contains any of the described sequestration components, mixed with any of the described activatable adhesive layer components. Typically, the materials have good adhesion to the substrate and do not weaken or swell when exposed to the activation fluid.

iv. In the Adhesive Layer

In some embodiments, the sequestration components are incorporated in the adhesive layer. In this embodiment, the materials are selected such that the sequestration of fluids begins preferably after the adhesive layer has been activated by the activation fluid. Suitable materials for the sequestration components include those described above.

v. In the Substrate

Sequestration components do not necessarily need to be only incorporated into one or more layers in the label. In some embodiments, the sequestration components are incorporated into the substrate. For example sequestration components can be coated on the surface of a substrate, such as a container, prior to placement of the activated adhesive side of the label on the substrate.

vi. In the Activation Fluid

In some embodiments, the sequestration components are optionally found in the activation fluid. In the activation fluid, the sequestration components may facilitate the generation of both quick tack and longer term adhesion upon activation of the adhesive by an aqueous or solvent-based solution.

The sequestration components can be added to the fluid activatable adhesive composition to enhance the adhesive performance of the hydrophobic and hydrophilic materials. The use of such sequestration components is beneficial as a means to enhance the penetration of water into the adhesive layer on a label as well as to control the kinetics of adhesive activation based on the distribution and redistribution of the activation fluid (or solvent) into both the hydrophilic and hydrophobic regions of the adhesive. In order for the adhesives to transition from their non-tacky to tacky state, they require a certain amount of water and/or solvent moisture to be present within the material. The retention of this moisture can be utilized as a mechanism to preserve viscoelastic flow of the polymer layer and in turn create a tacky label. However, excessive moisture can prevent the contact of the adhesive with the substrate by acting as a physical barrier to the generation of adhesive interactions resulting in the migration of the label from the desired application area on a substrate during down-stream processing.

An added benefit of the use of sequestration components is their ability to reduce the phenomena of ‘blocking’ in self-wound rolls of labels having a surface coated with the adhesive composition described herein.

These sequestration components described above are typically available as colloidal suspensions in a variety of solvents or as solids and are incorporated into the final adhesive composition at the desired concentrations. Concentrations of the suspensions typically range from about 10% to about 90% solids (weight of solids in the suspension to volume of liquid phase of suspension) in either an aqueous or solvent based suspension and present in the final dry film in a ratio from about 1% to about 25% (weight of dry solids in film as a ratio of other components dry weight in film). However, concentrations below or above this range are possible depending on the composition and/or the desired application.

Methods to ensure the homogenous distribution of these sequestration components in suspension include, but are not limited to, the use of agitation, surfactants, temperature and/or pH. The pre-saturation or treatment of the sequestration components using solvents, water, and/or adhesive components is also possible to alter their affinity for different components of the activating solution.

D. Adhesive Layer

The adhesive layer contains a fluid activatable adhesive. Following activation with a suitable activation fluid, the activated adhesive layer provides sufficient adhesive force to attach the label to the desired container substrate. Preferably, the adhesive layer rapidly activates, such as in less than 100 milliseconds, following contact with the activation fluid.

i. Materials

Exemplary fluid activatable adhesive layers and suitable activation fluids are discloses in U.S. Pat. No. 9,254,936 to Cho, et al., the disclosure of which is incorporated herein in its entirety.

The adhesive layer can contain can contain a single polymer (e.g., homopolymers, copolymer, terpolymer, etc.) or a mixture of polymers, such as homopolymers, copolymers, terpolymers, etc., combinations thereof, and additives dissolved in an appropriate carrier solvent.

1. Polymers

In some embodiments, the adhesive layer includes a polymer, such as:

polyvinyl alcohols, polyvinyl acetates, polyvinylpyrrolidones, polyvinylpyrrolidone-vinyl acetate copolymers, polyacrylic acids, polyethylene glycols, poly(2-ethyl-2-oxazoline), polyacrylamide copolymers, ethylene vinyl acetates, cellulose derivatives, particularly alkyl cellulose derivatives (cellulose acetate, methyl cellulose, ethyl/hydroxyethyl, hydroxymethylpropyl cellulose, etc.), ureas, gelatins, alginates, agars, gum arabics, natural and reclaimed rubbers, polyurethanes, non-carboxylated and carboxylated styrene-butadiene rubbers, polyacrylates based on the polymerization of monomers of methacrylates, methyl acrylate, ethyl acrylate, 2-chloroethyl vinyl ether, 2-ethylhexyl acrylate, hydroxyethyl methacrylate, butyl acrylate, butyl methacrylate or combinations of the previous, polyamides, polyesters, polyolefins, polyolefins containing maleic anhydride, polystyrenes, polyvinyl esters, polyvinyl ketones, polydiene elestomers, polyiso butylenes, poly butadienes, polychloroprenes, poly styrene acrylics, carboxylated acrylic polymers, styrene maleic anhydrides, styrene and/or butadiene polymers, or a combination of the above materials.

2. Carrier Solvents

The materials used to form the fluid activatable adhesive layer are applied to a facesheet using a suitable carrier solvent or solvents.

Suitable carrier solvent include, but are not limited to, water; acetone; acetonitrile; lower alcohols (i.e., having from 1-10 carbons) including, but not limited to, methanol, ethanol, isopropyl alcohol, n-propanol, n-butanol, 2-butanol, isobutanol, 2-methyl-2-butanol, n-pentanol, n-hexanol, 2-hexanol, cyclohexanol, n-heptanol, n-octanol, n-nonanol, n-decanol; glycols including, but not limited to, propylene glycol, ethylene glycol, and butylene glycol; fatty alcohols (i.e., having more than 10 carbons) including, but not limited to, undecanol, dodecanol, 1-tetradecanol, arachidyl alcohol, docosanol, tetracosanol, hexacosanol, octanosol, triacontanol, cetyl alcohol, stearyl alcohol, and polycosinol; ketones, such as methyl ethyl ketone; esters, such as lower (i.e., having from 1-10 carbons) acetates including, but not limited to, methyl acetate, ethyl acetate, n-propyl acetate, isopropyl acetate, isobutyl acetate, sec-Butyl acetate, tert-Butyl acetate, 3-methyl-1-butyl acetate; mineral spirits; oils, such as linseed oil and vegetable oil; citrus based solvents, such as limonene, other primary, secondary, and tertiary alcohols, and combinations thereof.

3. Additives

To decrease surface tension, enhance solvent spreading on the adhesive film surface, and/or promote activating solvent penetration, surfactants may be added to the fluid activatable adhesive layer. Classes of surfactants that can be used include anionic, cationic, non-ionic and amphoteric surfactants. Specific examples include lecithin, Span™-60, Span™-80, Span™-65, Tween™-20, Tween™-40, Tween™-60, Dynol™ 604 (Air Products), Surfynol™ (Air Products), Pluronics™ (BASF, Germany), Polysorbates™ (Tween™), Sodium dodecyl sulfate (sodium lauryl sulfate), Lauryl dimethyl amine oxide, Cetyltrimethylammonium bromide (CTAB), Polyethoxylated alcohols, Polyoxyethylene sorbitan, Octoxynol™ (Triton X100™), N,N-dimethyl-dodecylamine-N-oxide, Hexadecyl-trimethylammonium bromide (HTAB), Polyoxyl 10 lauryl ether, Brij™ 721™, Bile salts (sodium deoxycholate, sodium cholate), Polyoxyl castor oil (Cremophor™), Nonylphenol ethoxylate (Tergitol™), Cyclodextrins, Lecithin, or Methylbenzethonium chloride (Hyamine™)

The adhesive layer may also contain one or more sequestration components, as described above.

4. Polymer Blends/Mixtures

In one embodiment, the adhesive composition contains a blend or mixture of a polymeric resin and an emulsion/dispersion polymer. The polymers can be homopolymers, copolymers, terpolymers, etc., and combinations thereof. In particular embodiments, the blend or mixture contains a non-blocking resin in a continuous film that provides a non-blocking surface and an emulsion/dispersion polymer which provides adhesion to the substrate. The blend of the emulsion/dispersion polymer into the non-blocking resin disrupts the polymer film and allows for improved activation of the film by the activation spray.

a. Polymeric Resin

The adhesive composition blends typically contain a continuous phase, film-forming polymeric resin. The resin is typically non-blocking. The film-forming polymeric resin can be water-soluble or insoluble, alkaline-soluble, or combinations thereof. In particular embodiments, the resin is water-insoluble at neutral pH, which provides resistance to label removal when immersed in a cold water bath, but is alkaline-soluble which allows for removal of the label facilitating recycling of the substrate (e.g., glass or plastic container, such as a bottle).

The polymeric resin forms a continuous phase in which the other components of the adhesive composition (e.g., emulsion or dispersion polymer, etc.) will be dispersed when dried. This arrangement allows for any tack found in the emulsion/dispersion polymers to be hidden from the surface of the film by the continuous phase polymer, which prevents blocking. These polymers are non-tacky and either fully or partially soluble in the activation spray.

For increased humidity resistance, polymeric resins that are soluble in alkaline or acidic aqueous environments, but not soluble at a neutral pH while having some sensitivity to solvent are preferred. For these polymeric resins environmental moisture will have little to no effect on their physical properties. Their pH-dependent solubility allows for coating, while solvent sensitivity allows for activation.

Suitable polymeric resins include, but are not limited to, polystyrene acrylic resins, polyvinyl alcohols, polyvinyl acetates, polyvinylpyrrolidones, polyvinylpyrrolidone-vinyl acetate copolymers, polyacrylic acids, polyethylene glycols, poly(2-ethyl-2-oxazoline), polyacrylamide copolymers, styrene maleic anhydrides, ethylene vinyl acetates, cellulose derivatives, particularly alkyl cellulose derivatives (cellulose acetate, methyl cellulose, ethyl/hydroxyethyl, hydroxymethylpropyl cellulose, etc.), ureas, gelatins, alginates, agars, gum arabics, and other similar materials as well as combinations of the above materials. In particular embodiments, the resin is or includes polystyrene acrylic resins.

The concentration of the resin can vary depending on the adhesion and tack of the emulsion/dispersion polymer and the continuous phase formation of the of the resin polymer. If the emulsion/dispersion polymer is relatively non-tacky/blocking, then less resin polymer can be used. In contrast, if the emulsion/dispersion polymer is very tacky, more resin polymer is likely needed. The other required properties of the label also should be considered (e.g., caustic resolubility, ice water resistance, manufacturability, etc.). In some embodiments, the resin polymer is present in an amount of about 75% or less by weight of the adhesive composition, such as about 10% to about 70% by weight, preferably 25% to about 65%, preferably 30% to about 60% by weight. The concentration of the resin polymer can be less than 10% or greater than 75% in view of the desired properties for the label.

b. Emulsion/Dispersion Polymer

The fluid activatable adhesive layer typically contains an emulsion or dispersion polymer (also referred to herein as an “emulsion/dispersion polymer”. The emulsion or dispersion polymer forms a discrete phase dispersed in the continuous phase, film-forming polymeric resin. The emulsion or dispersion polymer provides the adhesion of the label to the substrate. The film-forming resin encapsulates the emulsion/dispersion polymer to provide a non-tacky surface which allows for storage of the labels as rolls or stacks. However, the blend of the emulsion/dispersion polymer into the non-blocking resin disrupts the continuous polymer film and allows for improved activation of the film by the activation spray to provide the necessary adhesion to affix the label to the substrate. The emulsion/dispersion polymer is generally hydrophobic or more hydrophobic than the resin polymer. The emulsion/dispersion polymer can adhere to the surface through a variety of interactions/mechanisms, including, but not limited to, hydrogen bonding or other intermolecular forces, such as hydrophobic interactions.

Suitable emulsion polymers include, but are not limited to, styrene acrylic emulsion polymers, natural and reclaimed rubbers, polyurethanes, non-carboxylated and carboxylated styrene-butadiene rubbers, polyacrylates based on the polymerization of monomers of methacrylates, methyl acrylate, ethyl acrylate, 2-chloroethyl vinyl ether, 2-ethylhexyl acrylate, hydroxyethyl methacrylate, butyl acrylate, butyl methacrylate or combinations of the previous, polyamides, polyesters, polyolefins, polyolefins containing maleic anhydride, polyvinyl esters, polyvinyl ketones, polydiene elestomers, polyiso butylenes, poly butadienes, polychloroprenes, as well as combinations of the above materials. Other material(s) having the desired long-term adherence characteristic may also be used. In particular embodiments, the emulsion or dispersion polymer is or includes styrene acrylic emulsion polymers.

The concentration of the emulsion/dispersion polymer can vary depending on the adhesion and tack of the emulsion/dispersion polymer and the continuous phase formation of the of the resin polymer. In some embodiments, the emulsion or dispersion polymer is present in an amount of about 40% or greater by weight of the adhesive composition, such as about 50% to about 90% by weight, preferably 50% to about 80%, preferably 60% to about 80% by weight. The concentration of the resin can be less than 40% or greater than 90% in view of the requirements/properties discussed above for the resin and the emulsion/dispersion polymer. The concentration of the resin and/or emulsion dispersion polymer can be varied due to the presence of additives which modify the properties of the adhesive composition.

ii. Properties

The adhesive layer provides good adhesion to the desired substrate. It is preferably also clear, i.e. has a low percent haze. The adhesive layer is preferably formulated for caustic removability, such that the container and label can be separated in a recycling plant or bottle washer.

In some embodiments, the coat weight of the adhesive layer 160 is from about 1 g/m² to about 50 g/m², preferably from about 5 g/m² to about 30 g/m², most preferably from 5 g/m² to 25 g/m². In some embodiments, the coat weight of the adhesive layer 160 is about 13 g/m².

E. Sequestration Layer

i. Components

In some embodiments, the sequestration layer 140 contains a terpolymer of vinyl caprolactam/vinylpyrrolidone (VP)/dimethylaminoethyl methacrylate, polyvinylpyrrolidone (PVP), PVP derivatives such as alkylated PVP, and those described in U.S. Pat. No. 8,784,697, incorporated herein by reference, polyacrylic acid (PAA), PAA derivatives such as polyalkacrylic acids (e.g., polymethacrylic acid), polyvinyl alcohol, or combinations thereof. In some embodiments, the sequestration layer 140 contains a terpolymer of vinyl caprolactam/vinylpyrrolidone (VP)/dimethylaminoethyl methacrylate.

The sequestration layer, if present, typically also contains one or more of the sequestration components 150 described above. For example, in some embodiments, the sequestration layer contains a high purity silica gel, with particle and pore sizes of 10-35 μm and 60 Å, respectively.

ii. Properties

The sequestration layer 140 adsorbs moisture from the adhesive layer or other layers of in the label system. In some embodiments, the coat weight of the sequestration layer 140 is from about 1 g/m² to about 50 g/m², preferably from about 5 g/m² to about 30 g/m², most preferably from 5 g/m² to 25 g/m². In some embodiments, the coat weight of the adhesive layer 150 is about 9 g/m², 13 g/m², or 14 g/m².

F. Primer Layer

i. Components

In some embodiments, the primer layer 180 contains polyester polyurethane. In some embodiments, the polyester polyurethane is formulated in an aqueous dispersion. Other materials that can be included in the primer layer 180 include, but are not limited to, water dispersible polyurethane, polystyrene and polystyrene acrylic water-based emulsions and dispersions, epoxy water-based emulsions, and polyacrylic acid and its salts, water-based emulsion polymers. In some embodiments, the primer layer 180 containing one or more of the materials used to form the primer layer 180, also contains the sequestration components 150 described above, such as high purity silica gel, with particle and pore sizes of 10-35 μm and 60 Å, respectively.

ii. Properties

Primer layer components include film-forming polymers that exhibit an affinity to the polymeric facesheet. The primer layer 180 promotes the adhesion of the adhesive layer 160 to the facesheet 130. In some embodiments, the coat weight of the primer layer 180 is from about 1 g/m² to about 25 g/m², preferably from about 5 g/m² to about 18 g/m², most preferably from about 10 g/m² to about 15 g/m². In some embodiments, the coat weight of the primer layer 180 is about 14 g/m².

G. Activation Fluid

The activation fluid activates the adhesive layer of the label. The activation fluid penetrates into the adhesive layer to moisten the hydrophilic and hydrophobic adhesive monomers without over-wetting the fluid activatable adhesive surface of the label, which can compromise adhesive performance. In addition, the activation fluid is compatible with mechanisms for applying activation fluids onto label, such as in stand-alone systems, label printers, labeling lines, or other apparatuses. The activation fluid is safe, non-toxic and complies with the guidelines established by regulatory boards for their intended purpose.

The purpose of the activation fluid is to introduce moisture into the fluid activatable adhesive layer to allow for the conversion of the adhesive from its non-tacky to tacky state. However, given the selection of both hydrophilic and hydrophobic fluid activatable adhesive monomers, one must account for the chemistries of the two or more polymers and the solvent used in the deposition process for enabling optimal activation. The activation fluid needs to penetrate into the hydrophilic regions of the fluid activatable adhesive layer to generate quick tack then redistribute and remain in the hydrophobic regions to maintain ultimate tack and long-term adhesion.

i. Components

1. Solvents

Suitable solvents include, but are not limited to, water; acetone; acetonitrile; lower alcohols (i.e., having from 1-10 carbons) including, but not limited to, methanol, ethanol, isopropyl alcohol, n-propanol, n-butanol, 2-butanol, isobutanol, 2-methy-2-butanol, n-pentanol, n-hexanol, 2-hexanol, cyclohexanol, n-heptanol, n-octanol, n-nonanol, n-decanol; glycols including, but not limited to, propylene glycol, ethylene glycol, and butylene glycol; fatty alcohols (i.e., having more than 10 carbons) including, but not limited to, undecanol, dodecanol, 1-tetradecanol, arachidyl alcohol, docosanol, tetracosanol, hexacosanol, octanosol, triacontanol, cetyl alcohol, stearyl alcohol, and polycosinol; ketones, such as methyl ethyl ketone; esters, such as lower (i.e., having from 1-10 carbons) acetates including, but not limited to, methyl acetate, ethyl acetate, n-propyl acetate, isopropyl acetate, isobutyl acetate, sec-Butyl acetate, tert-Butyl acetate, 3-methyl-1-butyl acetate; mineral spirits; oils, such as linseed oil and vegetable oil; citrus based solvents, such as limonene, other primary, secondary, and tertiary alcohols, and combinations thereof.

Low volatile solvents, such as ethylene glycol and propylene glycol, are particularly useful in extending the latency period.

Low surface energy solvents, such as isopropyl alcohol are particularly effective in increasing wet out on hydrophobic and/or low surface energy substrates.

Typically, the activation fluid contains at least two or more solvents. The first solvent or component is water or an aqueous solution which allows for rapid wetting and swelling of the hydrophilic regions of the fluid activatable adhesive to generate the quick tack responsible for the initial adhesion of the label to the substrate. However, as the water is drawn into the hydrophilic regions, quick tack is lost and must be replaced by ultimate or long-term tack, derived from the hydrophobic regions, which exhibit some swelling behavior in water. Thus, a second solvent or component is a non-aqueous (non-water) solvent containing hydrophobic chemical moieties which enhances the activation of the hydrophobic regions by increasing the permeability of the activation fluid into these regions. In a particular embodiment, the non-aqueous solvent is partly miscible or fully miscible with water. By using a mixture of solvents, the swelling of the hydrophilic regions can increase the surface area of the hydrophobic regions exposed for solvent penetration, resulting in the more rapid generation of ultimate tack. An optional third solvent or component, which preferably is a volatile material, may be used to aid in the removal of excess moisture from the adhesive layer to promote stronger adhesion.

In one embodiment, the solvent contains between about 1% and about 70%, preferably about 5% to about 70%, more preferably from about 10% to about 60%, most preferably about 10% to about 50% by weight of a non-toxic organic solvent in an aqueous solution. Care should be taken to match the polymer adhesive layer with suitable solvents that will activate the layer within the parameters discussed above. In a particular embodiment, the activation composition is a mixed solvent system with 5-70% w/w alcohol in water, preferably 10-50%, more preferably 20-40%, most preferably about 30% w/w mix of an alcohol in water. However, any polar solvent with some water miscibility containing hydrophobic chemical moieties may also be used. In particular embodiments, the solvent is a mixture of water and n-propanol, isopropanol, or combinations thereof. The concentration of the alcohol(s) can be about 1%, 2%, 5%, 10%, 15%, 20%, 25%, 30%, 35%, or 40% by weight of the fluid.

The solvent system can be varied for a particular adhesive composition in order to vary the properties of the adhesive composition. For example, the activating solvent can be varied to correlate with the selected hydrophilic and/or hydrophobic materials to achieve the desired performance. Generally, a solvent is a liquid fluid that either solubilizes or swells polymeric components of a solvent sensitive film. A non-solvent is a liquid fluid that does not solubilize or swell the polymeric components of a solvent sensitive film. In one embodiment, non-solvent can be incorporated into the activation fluid to reduce the overall average peel adhesion of the label. In another embodiment solvent with a vapor pressure greater than that of water at a given temperature can be incorporated into the activation fluid to lower the amount of time required to achieve acceptable ultimate adhesion values.

2. Additives

a. Surfactants

To decrease surface tension, enhance solvent spreading on the fluid activatable adhesive film surface, and/or promote activating solvent penetration, surfactants may be added to the activation fluid. Surfactants may also help in the delivery of the activation fluid by allowing for the creation of finer mists with smaller particle sizes during atomization (when used to apply the activation fluid to the adhesive layer of a label) which can promote adhesive activation by increasing the surface area for the interaction between the activating solution and the adhesive layer. Classes of surfactants that can be used include anionic, cationic, non-ionic and amphoteric surfactants. Specific examples include lecithin, Span™-60, Span™-80, Span™-65, Tween™-20, Tween™-40, Tween™-60, Dynol™ 604 (Air Products), Surfynol™ (Air Products), Pluronics™ (BASF, Germany), Polysorbates™ (Tween™), Sodium dodecyl sulfate (sodium lauryl sulfate), Lauryl dimethyl amine oxide, Cetyltrimethylammonium bromide (CTAB), Polyethoxylated alcohols, Polyoxyethylene sorbitan, Octoxynol™ (Triton X100™), N, N-dimethyl-dodecylamine-N-oxide, Hexadecyl-trimethylammonium bromide (HTAB), Polyoxyl 10 lauryl ether, Brij™ 721™, Bile salts (sodium deoxycholate, sodium cholate), Polyoxyl castor oil (Cremophor™), Nonylphenol ethoxylate (Tergitol™), Cyclodextrins, Lecithin, or Methylbenzethonium chloride (Hyamine™)

b. Plasticizers

The activation fluid optionally contains a plasticizer. Suitable plasticizers include, but are not limited to, low to medium molecular weight polyols and diols including, but not limited to polyethylene glycol, propylene glycol, ethylene glycol, other alcohols including, but not limited to, fatty alcohols, adipates, phosphates, azelletes, citrates, butyl cellosolve, polyol polyethers, including, but not limited to propylene glycol monomethyl ethyl ether, dipropylene glycol methylethyl ether, dibasic esters, benzoates and related acids, carbonates, lactones, phthalates, other hydrocarbon based oils and other solvents that are non-volatile at standard temperature and pressure (STP). In one embodiment, the plasticizer is a polyol polyether, such as those available under the tradename PLASTITILT® and MACOL®. Compounds marketed as surfactants can also be used as a plasticizer provided they provide the desired properties of no-volatility at operating temperatures and exhibit good solvency and/or plasticization of desired polymer adhesive layer.

c. Other Additives

Other additives may be incorporated into activation fluid, such as acids, bases, buffers, antimicrobial agents, stabilizers, emulsifiers, colorants, and/or defoaming agents, as needed for the particular application.

The additives may be added into the adhesive composition to modulate the performance of the labels, or for a variety of purposes, such as enhancing water penetration, reducing blocking, increasing quick tack and/or long-term adhesion as well as improving latency (the time between label activation and application). Potential classes of additives include, but are not limited to, colorants, both dye and pigment based, salts, sugars, other carbohydrates, polyelectrolytes, proteins, dry and liquid surfactants, resins, wetting agents, additive that provide desired lay flat properties of the labels, such as humectants, polyethylene glycol, and/or salts, other similar materials as well as combinations thereof. These additives can be incorporated into one or both of the polymer components, the polymer solvent, the activation fluid, or combinations thereof.

In particular, the use of non-volatile solvents, plasticizers, coalescents, oligomers, and/or polymers in the activation may extend the open time of a given adhesive composition. The additives in the activation spray should not clog the applicator used to apply the activation spray and should not require excessive cleanup.

H. Substrates

The activatable adhesive compositions described herein can be used to adhere labels to a variety of substrates.

A facesheet may be coated with an activatable adhesive composition described herein so that it contains a fluid activatable adhesive layer. The resulting fluid activatable adhesive layer is dry and non-tacky. The non-tacky adhesive layer remains inert until it is activated by a suitable activation fluid.

Following activation by the activation fluid, the (now tacky) activated adhesive layer can be applied to a substrate. Exemplary substrates include glass and plastics commonly used in commercial applications including, but not limited to, polyethylene terephthalate (PETE, PET, PETG), polyethylene (PE), polystyrene (PS), low-density polyethylene (LDPE), linear low-density polyethylene (LLDPE), high density polyethylene (HDPE), polypropylene (PP), polyvinyl chloride (PVC) and polyvinyl chloride films, and TYVEK®, as well as other low energy and thermoplastic substrates. The adhesive layer can also be applied to paper, cardboard, or metal surfaces. In particular embodiments, the substrate is glass or plastic, particularly PET.

In some embodiments, the adhesives are designed to adhere to a single specific substrate but do not adhere to other substrates. In one embodiment, the adhesive can be designed to have a specific strength of adhesion and/or mode of failure. For example, the adhesive bond has a lower failure point than the construct of the facesheet. In other embodiments, the adhesive is designed to adhere to a variety of substrates with little or no modification of the adhesive formulation.

i. Facesheets

Suitable facesheets include, but are not limited to, paper, coated paper, uncoated paper, metalized paper, saturated paper, cardboard, metal, glass, other clear or opaque films typically used to decorate a substrate, and plastics commonly used in commercial applications including, but not limited to, polypropylene (PP), polyethylene (PE), polyethylene terephthalate (PETE, PET, PETG), polystyrene (PS), cellulose, low-density polyethylene (LDPE), linear low-density polyethylene (LLDPE), high density polyethylene (HDPE), polyvinyl chloride (PVC) and polyvinyl chloride films, and TYVEK®, as well as other low energy and thermoplastic substrates. Other facesheets include porous substrates, such as natural or synthetic textiles and cellulosic fiber-based substrates

The adhesive composition (or blend) can be applied to the above listed facesheets utilizing typical web coating methods including, but not limited to, knife over roll, gravure, reverse-gravure, metering rod, slot die, curtain, and air knife coating methods.

ii. Properties

In some embodiments, the substrates possess high or low surface energy for interacting with the adhesive layer. High surface energy refers to surfaces in which chemical bonding, mechanical bonding, or both readily occur. Low surface energy refers to surfaces in which chemical bonding, mechanical bonding, or both do not readily occur.

### II. Methods of Making

The sequestration layer is coated onto the facesheet using any suitable technique, such as a gravure technique, knife over roll, reverse-gravure, metering rod, slot die, curtain, and air knife coating. The coating is applied, and then the web is carried through an air floatation oven. The coated sequestration layer is heated to temperatures of about 120° C. or greater, in order to drive out the moisture from the coating and to drive the moisture from the particulate sequestration materials. The coated web is then coated with an activatable adhesive layer using a coating or casting method and the drying process is repeated. Sufficient airflow and heat allow the sequestration materials to release its moisture for a time period from about 15 sec to about 30 sec, or about 2 mins.

The resulting fluid activatable adhesive layer is dry and non-tacky. The non-tacky adhesive layer remains inert until it is activated by the activation fluid.

Typically after coating the facesheet with the activatable adhesive layer and the sequestration materials, the desired indicia are printed onto the opposite side of the facesheet. Finally, if needed an overprint layer is coated or printed on top of the indicia. Alternatively, an overprint layer may be printed or coated on the opposite side of the facesheet and then the indicia may be printed on top of the overprint layer.

The coated web is then typically self-wound or stacked and ready to be activated and applied.

### III. Methods of Using

In use, one label at a time is provided, the adhesive layer is activated with an activation fluid, and the substrate to be labeled (e.g. a container) is contacted with the adhesive side of the label.

A. Activation Fluid Delivery

The activation fluid is preferably sprayed onto the label or onto the surface of the substrate. Various spray systems can be utilized to deliver the activation fluid to the adhesive layer of the label construction. In the examples where clarity and precision is needed, an inkjet style spray head is preferred. However, the activation fluid is compatible with standard mechanisms for applying fluids onto label, such as in stand-alone systems, label printers, labeling lines, or other apparatuses.

Coverage of the substrate with the activation fluid can range from 0.2 to 20-g of activation fluid/m² of substrate. Typically, if greater amounts of activation fluid are needed, the amount of sequestration components to be incorporated into the label construction will increase, as well.

B. Drying the Label

Optionally, after the label is placed on the surface of the substrate, the container is passed through a drying unit. The use of a drying unit, allows the adhesive layer and the sequestration components to be dried beyond a given equilibrium point of saturation with water, and thereby form strong bonds between label and the substrate. Optionally, a label that is attached to a substrate can be dried for a sufficient period of time to so that the label contains about 0 to 5% (wt/wt) water, preferably about 1 to 1% (wt/wt) water.

For example, when the sequestration components in one or more layers of the label are molecular sieves, as shown in FIG. 5B at 77° F., when at the equilibrium point of saturation, the molecular sieves adsorb 22 g of water per 100 g of molecular sieve when in an environment having 40% relative humidity. Drying this label after activation beyond the equilibrium point of saturation of the molecular sieves is generally required to achieve strong adhesion between the substrate and the facesheet.

In some embodiments, the sequestration components are dried until the label contains up to about 5% moisture (wt water/wt of the label), up to about 4% (wt/wt), up to about 3% moisture, up to about 2% (wt/wt) moisture, or up to about 1% (wt/wt) moisture. The percent water (percent moisture) in the label can be determined by any suitable method, such as gravimetrically, or using ASTMD 2216-10.

Optionally, the percent moisture in a label, can be determined by weighing the label, then subjecting the label to a further drying step to remove the remaining moisture (e.g. 100° C. for 30 minutes to 1 hour, or as needed depending on the size of the label), and then weighing the label after the drying step. The difference in the weight of the label after the drying step compared to prior to the drying step can be divided by the weight of the label prior to the drying step to determine the % moisture in the label prior to the drying step.

Solvents that are relatively non-ionic in character can be dried to moisture levels of less than 10 ppm. Capacities of 20 lbs. of water adsorbed per 100 lbs. of dried resin desiccant are obtainable. Reversibility can be accomplished using temperatures as low as 300° F. (150° C.), compared to the 365-650° F. (182° C.-340° C.) required by other molecular sieves.

C. Level of Adhesion

The level of adhesion of the labels to a substrate can be assessed at different time points and rated on a hand peel rating scale of 1 to 5. A rating of 1 indicates that the label has no adhesion to the substrate. Ratings of 2, 3, 4, and 5 indicate low adhesion, moderate adhesion, high adhesion, and strong adhesion, respectively, to the substrate. An exemplary substrate is glass. Any time points after placement of the label on the substrate can be used. Exemplary time points include at about 10 minutes and about 24 hours after attaching the labels to the substrate. A rating of 2 is estimated have a peel force of about 50-300 Win. A rating of 3 is estimated have a peel force of about 305-600 Win. A rating of 4 is estimated have a peel force of about 605-1000 Win. A rating of 5 indicates that the label has strong enough adhesion to break or tear the facesheet during removal.

The present invention will be further understood by reference to the following non-limiting examples.

### EXAMPLES

The adhesive layer has the same composition in each of the Examples provided below.

### Example 1

### Exemplary Fluid Activatable Polymeric Label with Sequestration Components in the Primer Layer for Adhering PET Labels to Glass Containers

The following three exemplary formulations were coated sequentially onto untreated PET (SG00-300, SKC).

The formulation of the primer layer 180 containing sequestration components 150, as described in Table 1, was applied directly to PET facesheet 130 with a #12 wire wound bar and dried in an oven at 60° C. The coat weight was 14 g/m².

TABLE 1
Primer layer formulation

| | | Percent (w/w) Solids |
|---|---|---|
| Components | Description | in dry film |
| Bayhydrol | Polyester polyurethane aqueous | 70 |
| UH240 | dispersion, Bayer Material Science, | |
| | (Pittsburg, PA) | |
| SiliaFlash ® | High purity silica gel, particle size | 30 |
| C60 | 10-35 μm, pore size 60 Å, Silicycle | |
| | (Quebec City, Quebec, Canada) | |

The formulation of the sequestration layer 150, as described in Table 2, was then applied directly to the primer layer 180 with a #10 wire wound bar and dried in an oven at 60° C. The coat weight was 9 g/m².

TABLE 2
Sequestration layer formulation

| | | Percent (w/w) |
|---|---|---|
| Components | Description | Solids in dry film |
| Gaffix ® | Vinyl Caprolactam/VP/ | 100 |
| Copolymer VC- | Dimethylaminoethyl Methacrylate | |
| 731 | Copolymer, Ashland Inc. | |
| | (Assonet, MA) | |

The components of the adhesive layer 160 described in Table 3 were mixed to a final percent solids level of 46% w/w. This formulation of the adhesive layer 160 was next applied to the sequestration layer 150 with a #12 wire wound bar and dried at 60° C. for 5 minute in an oven. A range of coat weights from 5 g/m² to 25 g/m² were found to be effective. A coat weight of 13 g/m² was used.

TABLE 3
Adhesive layer formulation

| | | Percent |
|---|---|---|
| | | (w/w) Solids |
| Components | Description | in dry film |
| Styrene Acrylic | Tg −50° C., Particle size 70-100 nm, | 63.3 |
| Emulsion | Mallard Creek Polymers (Charlotte, | |
| | NC) | |
| Rovene ® 6202 | Styrene acrylic resin, Mallard Creek | 20.0 |
| | Polymers (Charlotte, NC) | |
| Michem ® | Anionic polyethylene emulsion, | 5.4 |
| Emulsion 61335 | Michelman (Cincinnati, OH) | |
| Tego ® Glide 482 | Emulsion of polydimethylsiloxane, | 0.9 |
| | Evonik Industries (Esson, Germany) | |
| Tego ® Foamex | Emulsion of polyether siloxane | 0.4 |
| 1488 | copolymer containing fused silica, | |
| | Evonik Industries (Esson, Germany) | |
| Sodium | CFS Enterprises, Inc. (Charlotte, NC) | 10.0 |
| Bicarbonate | | |

The labels described in Example 1 were sprayed with an activation fluid solution of 30% n-propanol in deionized water at a level of about 12 g of activation fluid per m² of the labels. The sprayed labels were immediately applied to glass.

Label adhesion was assessed at 10 minutes and at 24 hours using a hand peel rating scale of 1 to 5. A rating of 1 indicated the label had no adhesion to the substrate, such as glass. Ratings of 2, 3, 4, and 5 indicated low adhesion, moderate adhesion, high adhesion, and strong adhesion, respectively, to the substrate, such as glass. A rating of 2 is estimated have a peel force of about 50-300 On. A rating of 3 is estimated have a peel force of about 305-600 g/in. A rating of 4 is estimated have a peel force of about 605-1000 g/in. A rating of 5 indicated that the label had strong enough adhesion to break or tear the facesheet during removal. When peeled at 10 minutes the labels described in Example 1 received a rating of 4. At 24 hours, the peel rating remained 4. This indicated excellent adhesion after short term and after long term bonding times.

### Example 2

### Fluid Activatable Polymeric Label without Sequestration Components for Comparison with Example 1 Label

In this example, the sequestration component (SiliFlash® C60) 150 was omitted from the formulation of the primer layer 180 described in Example 2, while the sequestration layer 150 and adhesive layer 160 remained the same, i.e., the same formulations described in Example 1.

The labels were sprayed with an activation fluid solution of 30% n-propanol in deionized water at a level of about 12 g of activation fluid per m² of the labels. The sprayed labels were immediately applied to glass. The resulting label had a hand peel rating of 4 at 10 minutes and 1.5 at 24 hours. In this example short term bonding was excellent, but the label failed to maintain adhesion after 24 hours.

### Example 3

### Exemplary Fluid Activatable Polymeric Label with Sequestration Components in the Sequestration Layer for Adhering PET Labels to Glass Containers

In Example 3, the primer layer 180 as described in Example 1 was omitted and sequestration components (SiliFlash® C60) 150, were added to the sequestration layer 140. The formulation of Example 3's sequestration layer 180 is described below in Table 4. The sequestration layer 140 containing the sequestration components 150 was applied directly to a PET facesheet (SG00-300, SKC) with a #12 wire wound bar and dried in an oven at 60° C. The coat weight was 14 g/m². The formulation of the adhesive layer 160 described in Table 3 was applied to the sequestration layer 140 containing the sequestration components 150 with a #12 wire wound bar and dried at 60° C. for 5 minute in an oven. The coat weight was 13 g/m².

TABLE 4
Sequestration Layer Formulation for Example 3

| | | Percent |
|---|---|---|
| | | (w/w) Solids |
| Components | Description | in dry film |
| Gaffix ® | Vinyl Caprolactam/VP/ | 70 |
| Copolymer VC- | Dimethylaminoethyl Methacrylate | |
| 731 | Copolymer, Ashland Inc. | |
| | (Assonet, MA) | |
| SiliaFlash ® C60 | High purity silica gel, particle size | 30 |
| | 10-35 μm, pore size 60 Å, Silicycle | |
| | (Quebec City, Quebec, Canada) | |

The labels were sprayed with an activation fluid solution of 30% n-propanol in deionized water at a level of about 12 g of activation fluid per m² of the labels. The sprayed labels were immediately applied to glass. When the label from Example 3 was applied to glass, the hand peel rating at 10 minutes was 4 and at 24 hours the rating was 2.5.

Comparing the results of Examples 1, 2, and 3, one can achieve variable adhesive strength in labels by altering the multi-layer build of the label. Two or three layer designs of the label, as well as, primer, sequestration and adhesive polymer choice allow for the development of labels with low (ratings of 1 to 2) to high adhesion (a rating of 4 or higher).

Unless defined otherwise, all technical and scientific terms used herein have the same meanings as commonly understood by one of skill in the art to which the disclosed invention belongs. Publications cited herein and the materials for which they are cited are specifically incorporated by reference.

Those skilled in the art will recognize, or be able to ascertain using no more than routine experimentation, many equivalents to the specific embodiments of the invention described herein. Such equivalents are intended to be encompassed by the following claims.

I claim:

1. A fluid activatable, liner-free label, comprising an indicia layer, a facesheet, a non-tacky, fluid activatable adhesive layer, and a plurality of sequestration components, wherein the facesheet has a moisture vapor transmission rate (MVTR) of less than 150 g/m²/24 hr.

2. The label of claim 1, wherein the plurality of sequestration components are in a layer between the facesheet and the fluid activatable adhesive layer.

3. The label of claim 1, wherein the plurality of sequestration components are included in the fluid activatable adhesive layer.

4. The label of claim 1, wherein the plurality of sequestration components have particle sizes of 1 to 20,000 nm.

5. The label of claim 1, wherein the plurality of sequestration components are molecular sieves.

6. The label of claim 5, wherein the molecular sieves are selected from the group consisting of aluminosilicate minerals, porous glass, activated carbon, montmorillonite intermixes, halloysite, silicon dioxide, and silica.

7. The label of claim 1, wherein the plurality of sequestration components are ion exchange resins.

8. The label of claim 7, wherein the ion exchange resins are quaternary ammonium resins.

9. The label of claim 1, wherein the fluid activatable adhesive layer comprises one or more alkaline soluble polymers selected from the group consisting of styrene-maleic anhydride resins, esters of styrene-maleic anhydride resins, styrene-maleic anhydride amic acid resins, styrene-maleic anhydride imide resins, ammonium and alkali metal salts of styrene-maleic anhydride resins, and combinations thereof and one or more emulsion polymers.

10. The label of claim 1, wherein the label is has a percent haze ranging from 0 to 10% haze following activation of the fluid activatable adhesive layer.

11. The label of claim 1, further comprising an overprint layer.

12. The label of claim 1, further comprising a primer layer.

13. The label of claim 1, further comprising a sequestration layer.

14. The label of claim 11, wherein the overprint layer and indicia layer are combined in a single layer.

15. The label of claim 1, wherein the coat weight of the fluid activatable adhesive layer is from about 1 g/m² to about 50 g/m².

16. The label of claim 13, wherein the coat weight of the sequestration layer is from about 1 g/m² to about 50 g/m².

17. The label of claim 1, wherein the primer layer comprises a material selected from the group consisting of polyester polyurethane, water dispersible polyurethane, polystyrene and polystyrene acrylic water-based emulsions and dispersions, epoxy water-based emulsions, polyacrylic acid and its salts, and water-based emulsion polymers.

18. The label of claim 13, wherein the sequestration layer comprises a terpolymer of vinyl caprolactam/vinylpyrrolidone (VP)/dimethylaminoethyl methacrylate, polyvinylpyrrolidone, polyvinylpyrrolidone derivatives, polyacrylic acid, polyacrylic acid derivatives, polyvinyl alcohol, or combinations thereof.

19. A method for applying the label of claim 1 to a substrate, comprising:
(a) activating the non-tacky, fluid activatable adhesive layer with an activating fluid comprising water and one or more organic solvents to form a tacky coating, and
(b) contacting the label to the substrate.

20. The method of claim 19, further comprising (c) drying the substrate and label after step (b).

21. The method of claim 20, wherein following step (c) the label contains up to about 2% moisture or less.

22. The method of any claim 19, wherein the activating fluid comprises a material selected from the group consisting of water, acetone, acetonitrile, methanol, ethanol, isopropyl alcohol, n-propanol, n-butanol, 2-butanol, isobutanol, 2-methy-2-butanol, n-pentanol, n-hexanol, 2-hexanol, cyclohexanol, n-heptanol, n-octanol, n-nonanol, n-decanol, undecanol, dodecanol, 1-tetradecanol, propylene glycol, ethylene glycol, butylene glycol, arachidyl alcohol, docosanol, tetracosanol, hexacosanol, octanosol, triacontanol, cetyl alcohol, stearyl alcohol, polycosinol, methyl ethyl ketone, ethyl acetate, mineral spirits, linseed oil, vegetable oil, citrus based solvents, limonene, and combinations thereof.

23. The method of claim 22, wherein the activating fluid comprises n-propanol.

24. The method of claim 19, wherein the substrate is selected from the group consisting of glass, plastic, paper, cardboard, and metal surfaces.
